(19) United States
(12) Patent Application Publication
(10) Pub. No.: US 2005/0285561 A1
(43) Pub. Date: Dec. 29, 2005

(54) Portable universal cordless (cellular phone) cellphone recharger (PUCCR or CCR)

(76) Inventor: Conrad Hugo Cheek JR., Washington, DC (US)

Correspondence Address: Conrad H. Cheek, Jr., 4334 H ST SE, Washington, DC, 20019, US

(21) Appl. No.: 11/128,151

(22) Filed: May 13, 2005

Related U.S. Application Data
(60) Provisional application No. 60/570,467, filed on May 13, 2004.

(51) Int. Cl. H02J 7/02

(52) U.S. Cl. 320/111

(57) ABSTRACT

A lightweight and portable cigar-lighter type power outlet for recharging cellular phones. The Cordless Cellphone Recharger (CCR) includes a case with an internal battery, an input power jack to charge the battery and a charge light to indicate that the battery is being charged. The CCR is recharged by a 12 volt DC battery charger at home or at work or by cigar lighter power outlet in a car.

### CROSS-REFERENCE TO RELATED APPLICATIONS

This application claims the benefit of U.S. Provisional Application Ser. No. 60/570,467 filed on May 13, 2004, which is herein incorporated by reference for all intents and purposes.

### BACKGROUND OF THE INVENTION

1. Field of the Invention

The present invention relates to a portable universal cordless cellphone charger that performs the same function as a cigar lighter jack in an automobile to power cellular phones and recharge cellular phone batteries.

2. Description of the Related Art

Cellular phones typically include a rechargeable battery for providing power to the phone. The battery had to be recharged using a standard 120 volt AC power source or a 12 volt DC automobile power source. Such standard sources are not always readily available or convenient.

### BRIEF DESCRIPTION OF THE DRAWINGS

FIG. 1 shows a top view with CCR battery charge jack J1 and battery charging light LED;

FIG. 2 shows a front view with cigar lighter outlet jack;

FIG. 3 shows a side view which may later contain a belt clip; and

FIG. 4 shows a schematic diagram with the battery pack and diode D1 which eliminates unwanted battery discharge through the LED.

### DETAILED DESCRIPTION

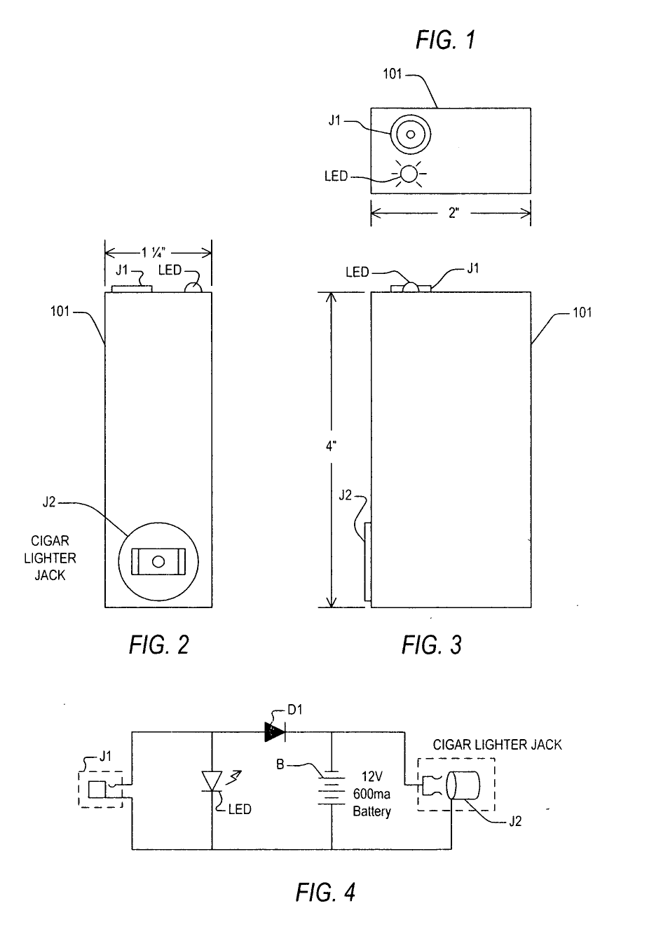

FIG. 1 shows a top view of a Cordless Cellphone Recharger (CCR) implemented according to an exemplary embodiment of the present invention. The CCR includes a case 101, and mounted onto the case 101 is a battery charge jack J1 and a battery charging light LED. FIG. 2 shows a front view of the case 101 including a cigar lighter outlet jack J2. FIG. 3 shows a side view of the case 101. FIG. 4 is a schematic diagram of the CCR incorporated within the case 101 including the battery charge jack J1 coupled to the LED, a diode D1, a battery pack B, and the lighter outlet jack J2.

The Cordless Cellphone Recharger can be recharged by connecting a 12 volt minimum 60 milliamp (mA) charger to the charge jack J1. When power is supplied to J1, the charge light LED illuminates and current flows through diode D1 to charge the 12 volt 600 mA battery B.

When a cellular phone battery (not shown) is low on charge it can be recharged and/or powered by inserting its cigar lighter power adapter (not shown) into the cigar lighter jack J2 of the Cordless Cellphone Recharger. Upon completion of recharging the cellphone, the adaptor is disconnected from the CCR. In the illustrated embodiment, this process can be repeated 3-5 times before the battery B of the CCR will need to be recharged.

The CCR is used in the same way and performs the same function of powering and or charging a cellular phone in the automobile. The advantage is that the Cordless Cellphone Recharger is lightweight (approximately 7 oz) and fits conveniently in a purse or pocket. The Cordless Cellphone Recharger is a light weight small portable cigar-lighter type power outlet. It contains its own battery B and the case 101 has an input charge jack J1 to charge the battery B and a charge light LED to show that it is being charged. The CCR is recharged by a 12 volt DC 60 mA battery charger (not shown) at home or at work or by cigar lighter power outlet in a car with a special adaptor (not shown).

1. (canceled)

2. A portable universal cordless cellphone recharger, comprising:
a case;
a cigar lighter jack mounted to said case;
a battery pack provided within said case and electrically coupled to said cigar lighter jack; and
a charge jack mounted to the case and electrically coupled to said battery pack.

3. The portable universal cordless cellphone recharger of claim 2, wherein said battery pack comprises a 12 Volt 600 milliamp battery.

4. The portable universal cordless cellphone recharger of claim 2, wherein said case, said cigar lighter jack, said charge jack, and said battery pack are lightweight.

5. The portable universal cordless cellphone recharger of claim 2, further comprising:
a charge light coupled to said charge jack; and
a diode coupled between said charge jack and said battery pack to prevent discharge into said charge light.

6. The portable universal cordless cellphone recharger of claim 2, further comprising:
said charge jack having first and second terminals;
said battery pack having a first terminal and having a second terminal coupled to said second terminal of said charge jack;
said charge light comprising an LED having an anode coupled to said first terminal of said charge jack and a cathode coupled to said second terminal of said charge jack;
a diode having an anode coupled to said first terminal of said charge jack and a cathode coupled to said first terminal of said battery pack; and
said cigar lighter jack having a first terminal coupled to said first terminal of said battery pack and a second terminal coupled to said second terminal of said battery pack.

7. The portable universal cordless cellphone recharger of claim 2, further comprising a charger configured to convert 120 Volt AC power to a 12 Volt 60 milliamp power source provided to a charge plug for interfacing said charge jack to charge said battery pack.

8. The portable universal cordless cellphone recharger of claim 2, further comprising a charger having a cigar lighter plug configured to plug into all automobile cigar lighter and a charge plug for interlacing said charge jack to provide 12 Volt DC power supplied by said automobile cigar lighter to charge said battery pack.
